(19) United States
(12) Patent Application Publication
(10) Pub. No.: US 2010/0007695 A1
(43) Pub. Date: Jan. 14, 2010

(54) LIQUID EJECTING APPARATUS

(75) Inventor: Hisashi MIYAZAWA, Okaya-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/488,080

(22) Filed: Jun. 19, 2009

(30) Foreign Application Priority Data
Jul. 14, 2008 (JP) 2008-182383
Apr. 15, 2009 (JP) 2009-098721

(51) Int. Cl. B41J 2/165

(52) U.S. Cl. 347/30

(57) ABSTRACT

A liquid ejecting apparatus that ejects a liquid from ejection nozzles formed in an ejection head. The liquid ejecting apparatus includes: a liquid receiver that is provided with a concave receiving the liquid from the ejection head; a suction pump that is connected to an opening formed in the concave and sucks the liquid in the concave; and a sucking auxiliary member that is applied with a negative pressure from the suction pump and drawn into the concave in a direction of the opening to assist the process of sucking the liquid in the concave by the suction pump.

### BACKGROUND

1. Technical Field

The present invention relates to a technique for ejecting a liquid from an ejection head.

2. Related Art

A so-called ink jet printer is capable of printing an image with a high quality by ejecting an exact amount of ink onto an exact position from minute ejection nozzles. Moreover, when various kinds of liquids instead of ink are ejected toward a substrate by use of this technique, an electrode, a sensor, a bio chip, or the like can be also manufactured.

In this technique, an exclusive ejection head is used in order to eject an exact amount of liquid such as ink onto an exact position. Water or a component of the liquid such as ink supplied to the ejection head is evaporated as time elapses, thereby increasing the viscosity of the liquid. When the viscosity of the liquid is increased, the exact amount of liquid of the ejection head cannot be ejected onto the exact position. Therefore, by covering the ejection nozzles with a cap while the liquid is not ejected, the liquid can be prevented from being thickened. When the ejection nozzles are covered with the cap for a long time, the liquid is of course thickened. Therefore, in this case, a process (a cleaning process) of depressurizing the cap by use of a suction pump and sucking the thickened liquid of the ejection head is performed.

Moreover, when the liquid which is not sucked by the suction pump and thus remains in the cap continues to be attached to the cap, the liquid is eventually dried. At this time, when the ejection nozzles are covered with the cap, the dried liquid is deprived of water from the liquid of the ejection nozzles. Then, the liquid of the ejection head is thickened more rapidly. In order to solve this problem, there has been suggested a technique for sucking the liquid attached to a passage together with external air by performing a hollow sucking process while introducing the external air into the cap after the cleaning process (JP-A-6-270419).

However, the suggested technique also has a problem that the liquid attached to the cap cannot be sufficiently sucked. In consequence, the problem occurs in that the liquid remaining in the cap is dried and solidified and a connection hole connected to the suction pump is thus clogged. In order to prevent the liquid of the ejection head from being thickened, the ink jet printer performs a process (a flushing process) of periodically ejecting a liquid toward a flushing receiver. When the liquid ejected toward the flushing receiver remains unremoved, a problem occurs in that the dried liquid is accumulated and thus touched to the ejection head.

### SUMMARY

An advantage of some aspects of the invention is that it provides a technique for completely sucking a liquid remaining in a cap or a liquid receiver such as a flushing receiver.

According to an aspect of the invention, there is provided a liquid ejecting apparatus that ejects a liquid from ejection nozzles formed in an ejection head. The liquid ejecting apparatus includes: a liquid receiver that is provided with a concave receiving the liquid from the ejection head; a suction pump that is connected to an opening formed in the concave and sucks the liquid in the concave; and a sucking auxiliary member that is applied with a negative pressure from the suction pump and drawn into the concave in a direction of the opening to assist the process of sucking the liquid in the concave by the suction pump.

In the liquid ejecting apparatus according to this aspect of the invention, the liquid receiver provided with the concave can receive the liquid from the ejection nozzles. The opening is formed in the concave and the liquid accumulated in the concave can be sucked from the opening. Of course, even when the liquid gathered in the concave can be sucked from the opening, it is difficult to suck the liquid attached to the concave. In order to solve this problem, there is provided the sucking-process auxiliary that is drawn into the concave in the direction of the opening by the negative pressure from the suction pump in order to allow the liquid in the concave to be easily sucked by the suction pump.

In this way, the liquid in the concave can be more surely sucked by operating the suction pump and drawing the sucking auxiliary member. In consequence, it is possible to prevent the liquid in the concave of a cap from being solidified and clogging the opening and prevent the ink of the ejection head from being thickened rapidly when the concave of the cap is brought into contact with the ejection head. Moreover, it is possible to prevent the liquid solidified in the concave of the liquid receiver from being accumulated and touching to the ejection head.

The liquid ejecting apparatus according to this aspect of the invention may have the following configuration. First, the sucking auxiliary member may be provided at a position different from that of the ejection head and may form a closed space together with the concave of the liquid receiver when coming in contact with the liquid receiver. In addition, when the suction pump operates in the state where the closed space is formed, the sucking auxiliary member may be deformed and drawn due to the negative pressure of the suction pump to decrease the volume of the closed space to assist the process of sucking the liquid by the suction pump.

With such a configuration, the liquid attached to the concave gathers round the opening, as the volume of the closed space is decreased. Since the liquid is finally sucked from the opening, the liquid attached to the concave can be more surely sucked. In consequence, it is possible to prevent the liquid in the concave of a cap from being solidified and clogging the opening and prevent the ink of the ejection head from being thickened rapidly when the concave of the cap is brought into contact with the ejection head. Moreover, it is possible to prevent the liquid solidified in the concave of the liquid receiver from being accumulated and touching to the ejection head.

In the liquid ejecting apparatus according to this aspect of the invention, a liquid absorbing member that absorbs the liquid may be further provided in the concave. In addition, the sucking auxiliary member may be drawn to compress the liquid absorbing member.

With such a configuration, the liquid absorbed by the liquid absorbing member can be squeezed and sucked by the suction pump. Accordingly, it is possible to prevent the liquid absorbed by the liquid absorbing member from being thickened or solidified in the liquid absorbing member and prevent the liquid absorbing member from being clogged.

The liquid ejecting apparatus according to this aspect of the invention may have the following configuration. First, the sucking-process auxiliary is provided close to the ejection head. The sucking auxiliary member may be brought into contact with the liquid receiver by using a first driving unit that brings the liquid receiver into contact with the ejection head and a second driving unit that changes a relative position between the liquid receiver and the ejection head.

With such a configuration, it is possible to bright the sucking auxiliary member into contact with the liquid receiver by using the first and second driving units provided in the liquid ejecting apparatus.

In the liquid ejecting apparatus according to this aspect of the invention, the sucking auxiliary member may be formed of an elastic air-tight film. The air-tight film may be deformed and drawn into the concave when the suction pump operates in the state where the concave of the liquid receiver is brought into contact to form the closed space.

With such a configuration, the air-tight film is elastically deformed in correspondence with the shape of the concave of the liquid receiver to push out the liquid attached to the concave. Accordingly, it is possible to suck and discharge the liquid in the concave more completely.

In the liquid ejecting apparatus according to this aspect of the invention which sucks the liquid in the concave together with the air-tight film, the concave of the liquid receiver may be formed in the following shape. That is, a portion where the side surface and the bottom surface of the concave intersect one another may be formed in a curved shape.

With such a configuration, when the air-tight film is sucked, it is easy to deform the air-tight film in correspondence with the portion where the side surface and the bottom surface of the concave intersect one another. Accordingly, it is possible to suck the liquid attached to the concave more completely.

In the liquid ejecting apparatus according to this aspect of the invention, the sucking auxiliary member may include a middle portion and a peripheral portion. Here, the middle portion is a portion that forms the closed space together with the concave when the liquid receiver is contacted. The peripheral portion is a portion that is provided in periphery of the middle portion and comes in contact with the liquid receiver. The middle portion may be slidable with respect to the peripheral portion and the middle portion may be drawn into the concave when the suction pump operates in the state where the closed space is formed.

With such a configuration, when the middle portion is drawn into the concave, the middle portion pushes out the liquid attached to the concave and thus the pushed liquid is accumulated in the opening in the concave. Accordingly, it is possible to more surely suck the liquid in the concave.

The liquid ejecting apparatus according to this aspect of the invention may have the following configuration. First, the liquid absorbing member absorbing the liquid, the sucking auxiliary member, and a recessed portion are provided in the concave. Here, the recessed portion is a concave to which the sucking auxiliary member is drawn. The sucking auxiliary member may be provided in a space with an inner wall surface of the concave with the liquid absorbing member interposed therebetween. The suction pump is connected to the recessed portion and the opening formed in the concave. In addition, the sucking auxiliary member may compress the liquid absorbing member by operating the suction pump and drawing the sucking auxiliary member to the recessed portion due to the negative pressure from the suction pump.

With such a configuration, the sucking auxiliary member can be provided in the concave of the liquid receiver. Therefore, even when the liquid receiver is not brought into contact with the sucking auxiliary member, the liquid absorbing member can be compressed just by operating the suction pump. In consequence, it is possible to squeeze the liquid absorbed by the liquid absorbing member and suck the liquid by the suction pump. Moreover, since the liquid can be squeezed and sucked from the liquid absorbing member in this manner, it is possible to prevent the liquid absorbed by the liquid absorbing member from being thickened or solidified and prevent the liquid absorbing member from being clogged.

As described above, the liquid ejecting apparatus according to this aspect of the invention which include the sucking auxiliary member in the concave may have the following configuration. First, a closed space is formed between the concave of the liquid receiver and the ejection head, when the liquid receiver is brought into contact with the ejection head. In addition, the sucking auxiliary member may be drawn to the recessed portion due to a pressure difference generated between the recessed portion and the concave when the suction pump operates.

The closed space is formed in the concave when the liquid receiver is brought into contact with the ejection head. Accordingly, when the suction pump operates in this state, the negative pressure from the suction pump is equally applied both to the concave and to the recessed portion. In consequence, the pressure difference is not generated between the recessed portion and the concave and the sucking auxiliary member is not drawn to the recessed portion. On the other hand, when the liquid receiver is not brought into contact with the ejection head, the closed space is not formed in the concave. Therefore, the negative pressure is not applied to the concave, even when the suction pump operates. In consequence, the pressure difference is generated between the recessed portion and the concave, and thus the sucking auxiliary member can be drawn to the recessed portion. Accordingly, based on whether the liquid receiver is brought into contact with the ejection head, it can be determined whether the liquid is squeezed from the liquid absorbing member.

In the liquid ejecting apparatus according to this aspect of the invention which include the sucking auxiliary member in the concave, the liquid absorbing member is made of a material such as a sponge having sufficiently high elasticity. The liquid absorbing member may restore its volume due to its restoring force when a compression force is removed from the sucking auxiliary member.

With such a configuration, the liquid absorbing member can restore the original shape due to the restoring force of the liquid absorbing member to again absorb the liquid. Accordingly, the configuration of the liquid ejecting apparatus is not complicated.

Instead of allowing the liquid absorbing member to have the elasticity, the following configuration may be embodied. First, there is provided a restoring member that is made of sufficiently high elasticity and deformed by a force compressing the liquid absorbing member. Examples of the restoring material include various springs (a coil spring, a plate spring, an air spring, etc.) and various rubber members having sufficient elasticity. In addition, the volume of the liquid absorbing member may be restored by the force restoring the original shape of the restoring member, when a compression force from the sucking auxiliary member against the liquid absorbing member is removed.

With such a configuration, since it is not necessary to provide the liquid absorbing member having the elasticity, the liquid absorbing member can be embodied in focus of other characteristics (for example, a characteristic for absorbing a liquid, a characteristic for stably maintaining the absorbed liquid, etc.).

### BRIEF DESCRIPTION OF THE DRAWINGS

The invention will be described with reference to the accompanying drawings, wherein like numbers reference like elements.

FIG. 1 is an explanatory diagram illustrating an overall configuration of a liquid ejecting apparatus by using a line printer as an example according to a first embodiment.

FIG. 2 is an explanatory diagram illustrating the detailed configuration of the line printer according to the first embodiment.

FIGS. 3A and 3B are explanatory diagrams illustrating the shape of a bottom surface of a head unit according to a first embodiment.

FIGS. 4A and 4B are explanatory diagrams illustrating a flushing process performed by the line printer.

FIGS. 5A and 5B are explanatory diagrams illustrating a cleaning process performed by the line printer.

FIG. 6 is an explanatory diagram conceptually showing a concave after the cleaning process.

FIG. 7 is an explanatory diagram illustrating the cross-section configuration of an ink removing unit provided on the bottom surface of the head unit according to the first embodiment.

FIGS. 8A and 8B are explanatory diagrams showing that ink attached to the concave is removed by use of the ink removing unit according to the first embodiment.

FIGS. 9A and 9B are explanatory diagrams showing that ink attached to the concave is removed according to a first modified example of the first embodiment.

FIGS. 10A to 10C are explanatory diagrams showing that the ink of the concave is more completely removed by further studying the shape of the concave according to a second modified example of the first embodiment.

FIG. 11 is an explanatory diagram illustrating the cross-section configuration of an ink removing unit according to a third modified example of the first embodiment.

FIGS. 12A and 12B are explanatory diagrams showing that the ink attached to the concave is removed by use of the ink removing unit according to the third modified example of the first embodiment.

FIG. 13 is an explanatory diagram illustrating the shape of the bottom surface of a head unit according to a second embodiment.

FIG. 14 is a perspective view schematically illustrating the shape of a cap unit according to the second embodiment.

FIGS. 15A and 15B are explanatory diagrams illustrating the detailed configuration of the cap unit.

FIG. 16 is an explanatory diagram showing that a line printer performs a cleaning process of sucking ink from ejection nozzles according to the second embodiment.

FIG. 17 is an explanatory diagram showing that the line printer performs a hollow sucking process in a state where the cap unit does not come in contact with the head unit according to the second embodiment.

FIG. 18 is an explanatory diagram illustrating a spring member for restoring an ink removing auxiliary member according to a first modified example of the second embodiment.

FIG. 19 is an explanatory illustrating a switching valve provided in a negative pressure passage according to a second modified example of the second embodiment.

### DESCRIPTION OF EXEMPLARY EMBODIMENTS

Hereinafter, embodiments will be described in the following order in order to clearly describe the contents of the above-described aspects of the invention.
A. First Embodiment
A-1. Configuration of Apparatus
A-2. Maintenance Process
A-3. First Modified Example
A-4. Second Modified Example
A-5. Third Modified Example
B. Second Embodiment
B-1. Configuration of Apparatus
B-2. Process of Maintaining Function of Ink Absorbing Member
B-3. First Modified Example
B-4. Second Modified Example

### A. First Embodiment

### A-1. Configuration of Apparatus

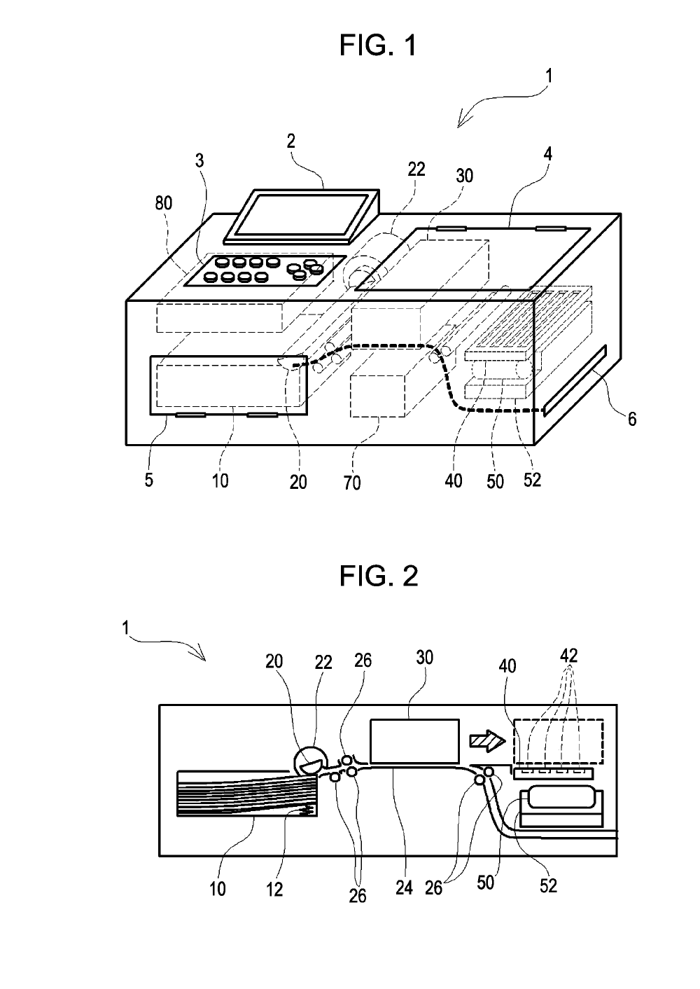

FIG. 1 is an explanatory diagram illustrating an overall configuration of a liquid ejecting apparatus by using a line printer 1 as an example according to a first embodiment. As illustrated, the line printer 1 according to the first embodiment has a substantially outer box-like shape. A monitor panel 2, an operation panel 3 operated by a user, and a maintenance door 4 used to perform various maintenance processes of the line printer 1 are formed on the upper surface of the line printer 1. A feeding door 5 opened when print sheets are loaded is formed on the front surface of the line printer 1. A discharging port 6 discharging each of the print sheets subjected to a printing process is formed on the right surface in front view.

A plurality of units and components carrying out various functions are mounted in the line printer 1. First, a head unit 30 ejecting ink onto the print sheet is provided at the substantially middle position of the line printer 1. In addition, a power unit 70 is provided below the head unit 30. Ink cartridges storing ink are mounted on the head unit 30 and are configured so as to eject ink from the bottom surface of the head unit 30 to print an image on the print sheet.

A feeding cassette 10 to which the print sheets are loaded is provided at the lower left position of the head unit 30 on the surface of FIG. 1. Moreover, a feeding roller 20 is provided at a position which is in contact with the right edge of the upper surface of the feeding cassette 10. A feeding motor 22 is connected to the inside of the feeding roller 20. When the feeding motor 22 is driven to rotate the feeding roller 20, one print sheet is transported from the feeding cassette 10 to the head unit 30. Then, when the print sheet passes below the lower surface of the head unit 30, the ink is ejected to print an image. In FIG. 1, a transport passage of the print sheet is indicated by a bold dashed line. After the image is printed, the print sheet is transported to the lower side and then discharged from the discharging port 6.

An area on the right side of the head unit 30 on the surface is a vacant space. A cap unit 40, a suction pump 50, a waste liquid tank 52, and the like are disposed below the vacant space. In addition, a control unit 80 controlling various kinds of movement of the line printer 1 is disposed at a position directly below a portion in which the monitor panel 2 or the operation panel 3 are formed.

FIG. 2 is an explanatory diagram illustrating the detailed configuration of the line printer 1 according to the first embodiment. In FIG. 2, the inside configuration is conceptually shown, when the line printer 1 is viewed from a front side. Hereinafter, operations of the units and the components mounted on the line printer 1 will be described with reference to FIG. 2. First, the plural print sheets are loaded in the feeding cassette 10. The print sheets loaded in the feeding cassette 10 are pushed up by a spring 12 and pressed by the feeding roller 20 provided on the upper side. The feeding roller 20 is a thin long member which has a substantially semi-circular cross-section formed by halving a thin and long column made of metal in a longitudinal direction. The side surface forming the circumferential portion is formed of a rubber material. The feeding motor 22 is connected to one end of the feeding roller 20. By allowing the feeding motor 22 to rotate the feeding roller 20, only one print sheet is sent from the feeding cassette 10 to the head unit 30.

A plurality of guide rollers 26 are provided between the feeding roller 20 and the head unit 30. By allowing a motor (not shown) to drive and rotate the guide rollers 26, the guide rollers 26 transport the print sheet to the head unit 30 while guiding the print sheet.

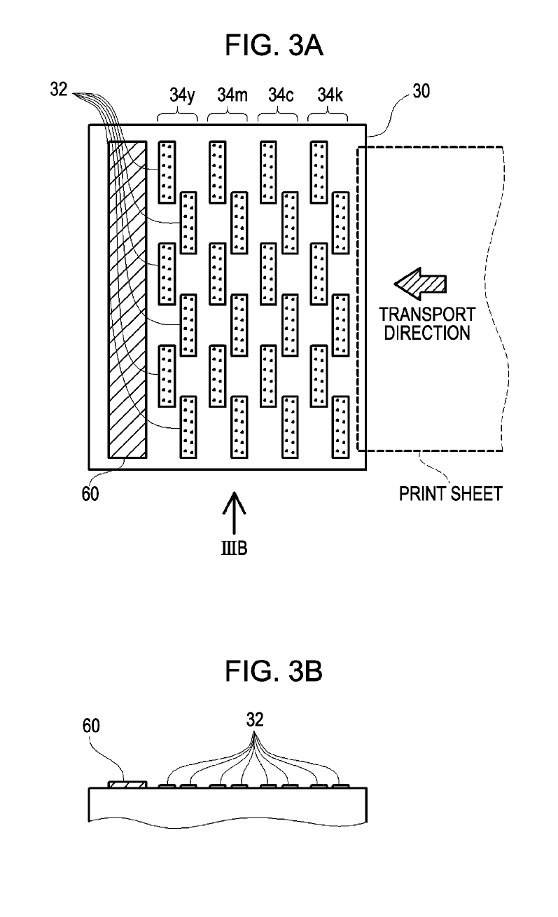

The head unit 30 is provided in the transport passage of the print sheet just as the head unit 30 rides the print sheet. A plurality of ejection heads ejecting ink are provided on the bottom surface (that is, a surface opposed to the print sheet) of the head unit 30 (see FIG. 3). Ink cartridges individually storing four kinds of ink, that is, cyan ink (C ink), magenta ink (M ink), yellow ink (Y ink) and black ink (K ink) are mounted on the head unit 30. The ink stored in the ink cartridges is ejected from a plurality of ejection heads provided on the lower surface of the head unit 30.

FIGS. 3A and 3B are explanatory diagram illustrating the shape of the bottom surface of the head unit 30 according to the first embodiment. In FIG. 3A, the head unit 30 viewed from the bottom surface (the surface facing the print sheet) is shown. In FIG. 3B, the shape of the bottom surface of the head unit 30 viewed from a direction of IIIB shown in FIG. 3A is shown. As shown in FIG. 3A, four sets, each one of which is constituted by six nozzle units 32 (the total twenty four nozzle units) having a substantially rectangular shape, are provided on the bottom surface of the head unit 30 according to the first embodiment. Moreover, the six nozzle units 32 of each set are arranged in two rows, each of which includes three nozzle units 32, so that the nozzle units 32 in the rows are interlaced. In each of the nozzle units 32, a plurality of ejection nozzles ejecting ink are arranged in rows. The six nozzle units 32 all constitute one ejection head 34 by arranging the nozzle units 32 in the interlaced manner. As described above, the twenty four nozzle units 32 are provided in the head unit 30 according to the first embodiment. Accordingly, four ejection heads 34 are thus formed. The ejection heads 34 include an ejection head 34y ejecting Y ink, an ejection head 34m ejecting M ink, an ejection head 34c ejecting C ink, and an ejection head 34k ejecting K ink.

As shown in FIG. 2, a substantially flat unit called a platen 24 formed opposite the bottom surface of the head unit 30 is provided below the head unit 30. The print sheet transported by the feeding roller 20 and the guide rollers 26 is supplied onto the platen 24. While the print sheet is transported on the platen 24, the ink is ejected from the ejection heads arranged on the bottom surface of the head unit 30 to print an image. The print sheet on which the image is printed in this manner is transported downward by guide rollers 26 provided on the downstream side of the platen 24, passed below the waste liquid tank 52, and then discharged from the discharge port 6 to the outside of the line printer 1.

As described above, the area on the right side (the downstream side of the transport direction of the print sheet) of the head unit 30 on the surface of FIG. 2 is the vacant space, and the cap unit 40 is provided below the vacant space. On the upper surface of the cap unit 40, concaves 42 receiving the ink are formed at positions corresponding to the ejection heads arranged on the bottom surface of the head unit 30. In addition, as shown by an arrow indicated by diagonal lines in FIG. 2, the head unit 30 is slid up to a position above the cap unit 40 to perform a maintenance process described below.

### A-2. Maintenance Process

The maintenance process is a process which is performed in order to prevent the ink from being not ejected since the ink cannot be appropriately ejected when the ink of the ejection heads 34 are thickened. As the maintenance process, there are three representative processes: a maintenance process called “a flushing process”, a maintenance process called “a cleaning process”, and a maintenance process called “a capping process”. Hereinafter, these processes will be simply described.

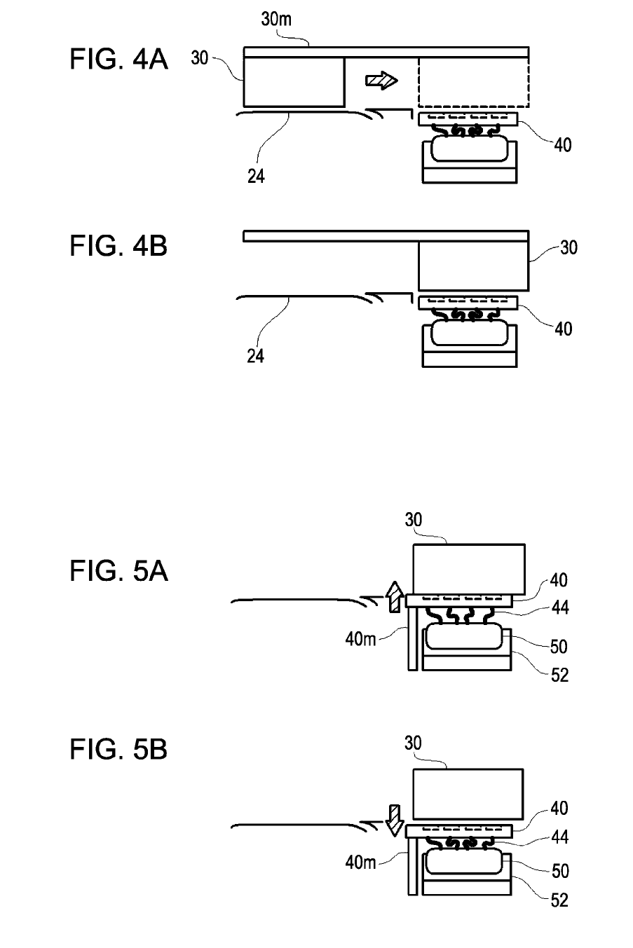

FIGS. 4A and 4B are explanatory diagrams showing that the line printer 1 performs the flushing process according to the first embodiment. In the flushing process, the head unit 30 is first moved up to a position above the cap unit 40. FIG. 4A shows that the head unit 30 is moved toward the cap unit 40 by an actuator 30m. When the head unit 30 is moved up to the position above the cap unit 40, as shown in FIG. 4B, the ejection heads 34 of the head unit 30 ejects the ink toward the concaves 42 formed in the cap unit 40. When the ink of the ejection heads 34 is slightly thickened, the flushing process is performed to restore the viscosity of the ink of the ejection heads 34 to a normal range by ejecting the thickened ink toward the concaves 42 and supplying new ink corresponding to an amount of ejected ink to the ejection heads 34. After the flushing process, the head unit 30 is again moved to a position above the platen 24 to resume the printing process.

FIGS. 5A and 5B are explanatory diagrams showing that the line printer 1 performs the cleaning process according to the first embodiment. Like the flushing process, the head unit 30 is also moved up to the position above the cap unit 40 in the cleaning process (see FIG. 4A). Subsequently, as shown in FIG. 5A, the cap unit 40 comes in contact with the bottom surface of the head unit 30 by allowing an actuator 40m to move up the cap unit 40. In this way, each of the concaves 42 formed in the cap unit 40 forms a closed space in the circumference of the corresponding ejection head 34. When the suction pump 50 operates in this state, the closed spaces formed by pressing the concaves 42 become a negative pressure state, so that the ink is forcibly sucked from the ejection nozzles. The sucked ink flows in the suction pump 50 through tubes 44 and is discharged to the waste liquid tank 52.

In the cleaning process, the ink of the ejection heads 34 is forcibly sucked. Accordingly, even when the thickened ink of the ejection heads 34 cannot be restored in the flushing process, the viscosity of the ink of the ejection heads 34 can be restored to a normal range. When a predetermined amount of ink is sucked, as shown in FIG. 5B, the cap unit 40 is moved down to the original position thereof and then the head unit 30 is again moved above the platen 24. By doing so, the printing process can be resumed. Immediately after the ink is sucked from the ejection nozzles, the concaves 42 are filled with ink. Accordingly, when the cap unit 40 is moved down, a hollow sucking process of sucking the ink from the concaves 42 may be first performed in a state where an opening valve (not shown) is opened, and then the cap unit 40 may be moved down.

The ink of the ejection nozzles is exposed to the external air. Therefore, as water is gradually evaporated even at the time not performing the printing process, the ink thus gets to be thickened. In order to prevent this problem, as shown in FIG. 5A, the maintenance process (the capping process) of bringing the cap unit 40 into contact with the bottom surface of the head unit 30 is performed while an image is not printed. When the bottom surface of the head unit 30 is capped, the water of the ink can be prevented from being evaporated from the ejection nozzles, thereby preventing the ink from being thickened.

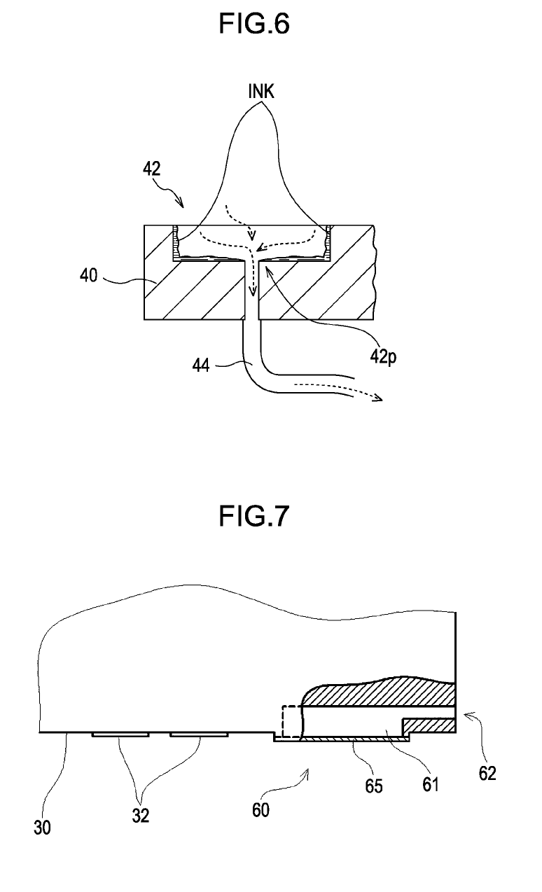

FIG. 6 is an explanatory diagram conceptually showing each concave 42 after the cleaning process. As described above, the ink is ejected toward the concaves 42 during the flushing process and the concaves 42 are filled with the ink during the cleaning process. Accordingly, after the cleaning process, the ink is attached to the concaves 42. When a large amount of ink is not ejected during the flushing process, or when the suction pump 50 operates after the flushing process, the ink is also attached to the concaves 42. In addition, it is difficult to suck the ink attached to the concaves 42 in this manner, no matter how the suction pump 50 operates. Arrows indicated by dashed lines in FIG. 6 shows that air is sucked from an opening 42p formed in the concave 42 through the tube 44 by operating the suction pump 50.

As shown in FIG. 6, it is difficult to suck the ink attached to the concaves 42 no matter how the suction pump 50 operates. However, when the ink attached to the concaves 42 remains unremoved, the attached ink is dried in the concaves 42. In consequence, a problem occurs in that a hole connected to the suction pump is clogged or the dried liquid is accumulated and eventually touched to the ejection heads. Moreover, when the ejection head 34 is covered in the concaves 42 to which the dried ink is attached, the dried ink deprives water from the ink of the ejection nozzles, thereby making the ink of the ejection heads 34 thickened more rapidly. In order to solve the problems, in the line printer 1 according to the first embodiment, an ink removing unit 60 which removes the ink attached to the concaves 42 is provided on the bottom surface of the head unit 30, as shown in FIGS. 3A and 3B.

FIG. 7 is an explanatory diagram illustrating the cross-section configuration of the ink removing unit 60 provided on the bottom surface of the head unit 30 according to the first embodiment. As described above with reference to FIGS. 3A and 3B, the ink removing unit 60 has a rectangular shape with the same length as that of the ejection head 34, when viewed from the bottom surface (a side of the print sheet). However, when viewed from a horizontal direction, the ink removing unit 60 has the cross-section configuration in which an airtight diaphragm 65 made of a good elastic material which does not pass air is disposed on the bottom surface of a thin long air chamber 61. A small air hole 62 is formed in the air chamber 61 so as to pass external air. In addition, the ink removing unit 60 is provided so as to protrude more slightly than the nozzle units 32 arranged on the bottom surface of the head unit 30.

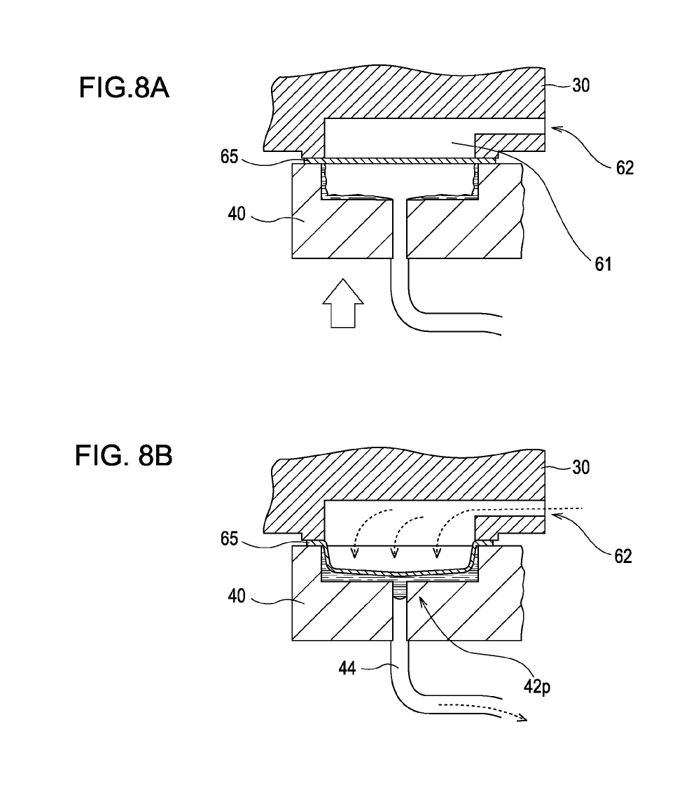

FIGS. 8A and 8B are explanatory diagrams showing the ink attached to each concave 42 is removed by the ink removing unit 60 according to the first embodiment. When the ink attached to the concave 42 is removed, the ink removing unit 60 is first moved up to a position above the concave 42. Then, by moving up the cap unit 40, the concave 42 is pressed against the diaphragm 65 of the ink removing unit 60. FIG. 8A shows that the concave 42 is pressed against the diaphragm 65 of the ink removing unit 60. It is sufficient that the air chamber 61 of the ink removing unit 60 has the same size as the size of the concave 42 opened upward. However, in order to allow the ink removing unit 60 to be easily positioned, it is preferable that the size of the air chamber 61 is slightly larger than that of the concave 42. Moreover, the ink removing unit 60 is provided so as to protrude more slightly than the nozzle unit 32. Therefore, when a concave 42 is pressed by the ink removing unit 60, there is no problem that another concave 42 becomes adjacent to the nozzle unit 32 and thus different ink is mixed to each other.

When the concave 42 is pressed against the diaphragm 65 of the ink removing unit 60, air is sucked from the opening 42p in the concave 42 by operating the suction pump 50. The diaphragm 65 is made of the good elastic material and the air chamber 61 communicates with the outside through the air hole 62. Therefore, the diaphragm 65 is drawn toward the concave 42 as the air of the concave 42 is sucked out. At this time, the ink attached to the concave 42 is pushed out by the diaphragm 65, thus accumulated around the opening 42p connected to the tube 44, and finally sucked by the suction pump 50. FIG. 8B shows that the ink attached to the concave 42 is pushed out by the diaphragm 65 drawn toward the concave 42 and sucked by the suction pump 50. In this way, the ink attached to the concave 42 can be almost completely sucked. In consequence, various problems caused due to the dryness of the ink attached to the concave 42 do not occur. Moreover, by allowing the ink of the ejection heads 34 to keep an appropriate state, it is possible to print an image with a high quality.

### A-3. First Modified Example

In the above-described first embodiment, the opening 42p connected to the suction pump 50 through the tube 44 is formed in each of the concaves 42 of the cap unit 40. However, an ink absorbing member 68 that absorbs the ink may be provided in the concave 42.

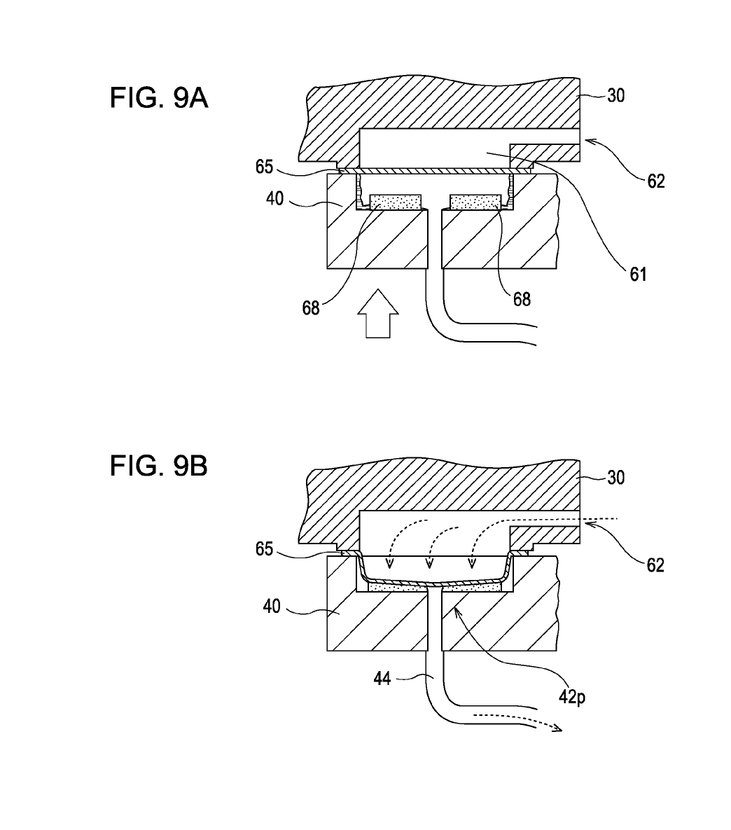

FIGS. 9A and 9B are explanatory diagrams showing that the ink absorbing member 68 provided in the concave 42 removes the ink of the concave 42 according to a first modified example of the first embodiment. A different point from the above-described first embodiment with reference to FIGS. 8A and 8B is that the ink absorbing member 68 is provided in the concave 42. According to the first modified example shown in FIGS. 9A and 9B, when the ink attached to each concave 42 is removed, the ink removing unit 60 is first also moved up to the position above the concaves 42. Then, by moving up the cap unit 40, each concave 42 is pressed against the diaphragm 65 of the ink removing unit 60 (see FIG. 9A). Subsequently, by operating the suction pump 50, the air is sucked from the opening 42p formed in the concave 42. Then, the diaphragm 65 is drawn toward the concave 42, pushes out the ink attached to the concave 42, and compresses the ink absorbing member 68 provided in the concave 42. In consequence, the ink absorbed by the ink absorbing member 68 is squeezed, accumulated around the opening 42p, and finally sucked by the suction pump 50. FIG. 9B shows that the diaphragm 65 drawn toward the concave 42 compresses the ink absorbing member 68.

According to the above-described first modified example of the first embodiment, not only the ink attached to the concave 42 but also the ink absorbed by the ink absorbing member 68 can be sucked from the opening 42p. In consequence, it is possible to prevent the ink absorbed by the ink absorbing member 68 from being dried and prevent the ink absorbing member 68 from causing the clogging. Moreover, since the ejection heads 34 are capped in the state where the ink of the ink absorbing member 68 is dried, it is possible to prevent the ink of the ejection heads 34 from being thickened.

### A-4. Second Modified Example

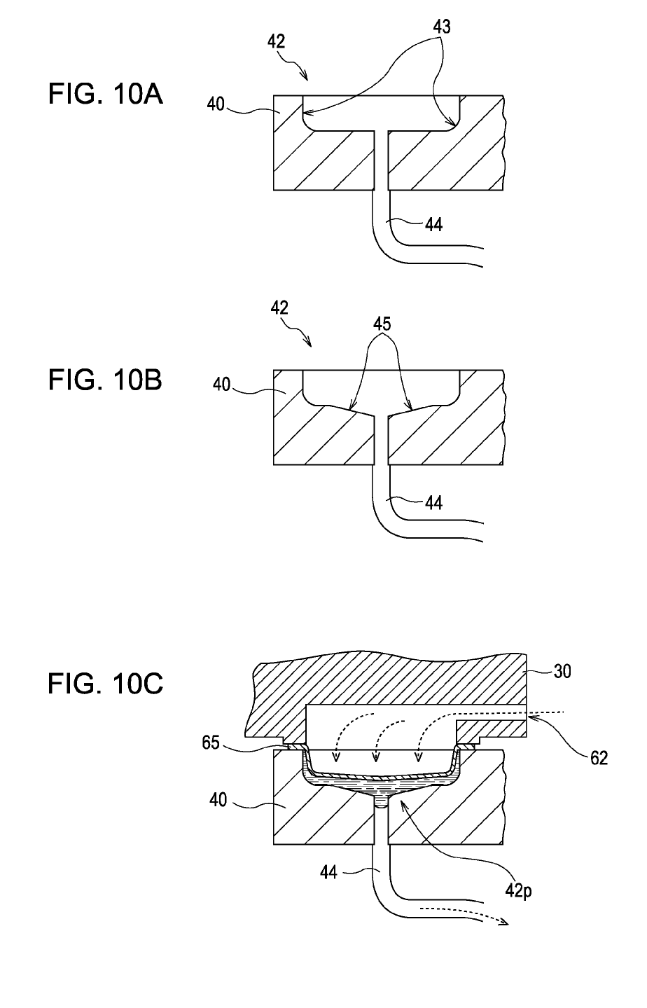

In the above-described first embodiment, the ink attached to the concave 42 can be more completely sucked by modifying the shape of the concaves 42 of the cap unit 40. FIGS. 10A to 10C are explanatory diagrams the ink of the concave 42 is more completely removed by further studying the shape of the concave 42 according to a second modified example of the first embodiment. For example, as shown in FIG. 10A, corners 43 where the bottom surface and the side surfaces of the concave 42 intersect with each other are formed in a curved surface shape. Alternatively, corners where only the side surfaces of the concave 42 intersect with each other may be also formed in a curved surface shape. As shown in FIG. 10B, inclined surfaces 45 may be formed round the opened portion of the tube 44 connected to the suction pump 50 so that the opened portion is formed lower. FIG. 10C shows that the ink attached to the concave 42 is removed when the concave 42 is formed in these shapes.

Since the corners (the corners where the bottom surface and the side surfaces intersect with each other or the corners where only the side surfaces intersect with each other) of the concave 42 is formed in the curved surface shape, it is easy to follow the diaphragm 65. Therefore, the ink attached to the concave 42 can be more completely pushed out by the diaphragm 65. Moreover, when the inclined surfaces are formed round the opened portion of the tube 44 on the bottom surface of the concave 42, it is easy to accumulate the ink pushed out by the diaphragm 65 in the opened portion of the tube 44. In consequence, it is possible to more completely suck the ink attached to the concave 42.

### A-5. Third Modified Example

In the above-described first embodiment, the ink is removed by drawing the diaphragm 65 provided in the ink removing unit 60 by the negative pressure of the suction pump 50 and then allowing the diaphragm 65 to push out the ink attached to the concave 42. However, when the ink attached to the concave 42 can be pushed out, an object to be drawn is not required to be the diaphragm 65. For example, by providing an activator in a part of the ink removing unit 60 and drawing the activator, the ink attached to the concave 42 may be pushed out. The activator according to the second embodiment is described below.

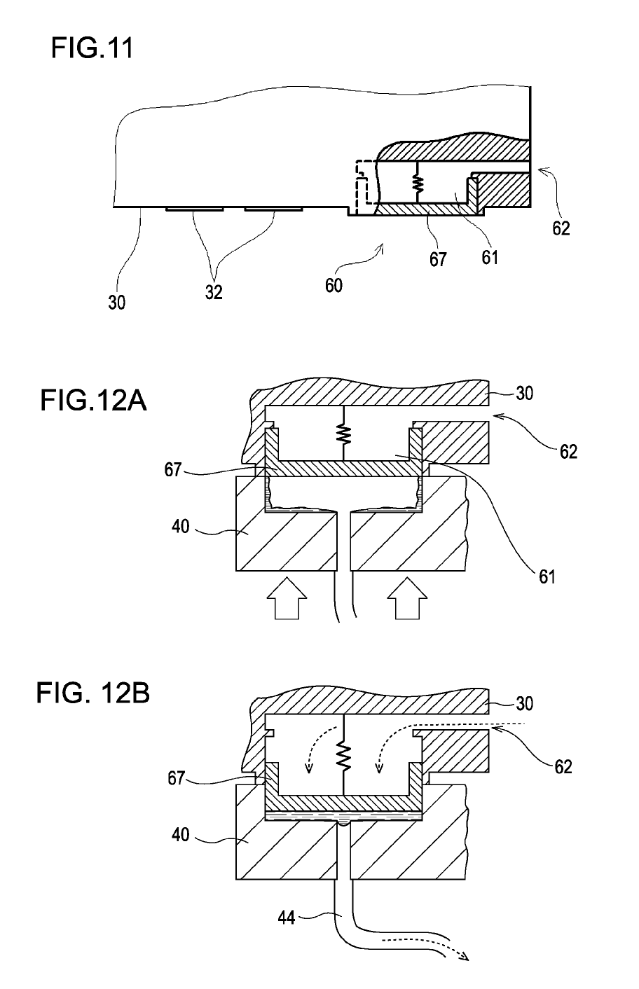

FIG. 11 is an explanatory diagram illustrating the cross-section configuration of the ink removing unit 60 according to a third modified example of the first embodiment. In the ink removing unit 60 according to the third modified example, a big difference from the above-described first embodiment is that a middle activator 67 is provided so as to be slidable in the air chamber 61 and the remaining configuration is almost the same. As shown in FIG. 11, a weak spring is provided in the air chamber 61 and the middle activator 67 is drawn nearly up to a surface position on a side of the air chamber 61 in a normal state.

FIGS. 12A and 12B are explanatory diagrams showing the ink attached to the concave 42 is removed by the ink removing unit 60 according to the third modified example of the first embodiment. When the ink attached to the concave 42 is removed, the ink removing unit 60 is first also moved up to the position above the concave 42 and then the cap unit 40 is moved up according to the third modified example. In this way, the concave 42 comes in contact with the middle activator 67 of the ink removing unit 60. FIG. 12A shows that the middle activator 67 of the ink removing unit 60 is pressed toward the concave 42.

Next, as in the above-described first embodiment, the air in the concave 42 is sucked by operating the suction pump 50. Then, since the concave 42 below the middle activator 67 becomes a negative pressure but the air chamber 61 above the middle activator 67 remains to be in the atmospheric pressure, the middle activator 67 is drawn toward the concave 42 due to a difference between the upper and lower pressures. At this time, the ink attached to the concave 42 is pushed out by the middle activator 67, thus accumulated around the opening 42p connected to the tube 44, and finally sucked by the suction pump 50. FIG. 12B shows that the ink attached to the concave 42 is pushed out by the middle activator 67 drawn into the concave 42 and sucked by the suction pump 50. In this way, it is possible to almost completely suck the ink attached to the concave 42.

In the above-described ink removing unit 60 according to the third modified example, the middle activator 67 is drawn due to the negative pressure of the suction pump 50. Accordingly, when the shape of the middle activator 67 is matched with the shape of the concave 42, the ink attached to the corners of the concave 42 can be also pushed out by the middle activator 67. Therefore, it is possible to completely suck the ink. Moreover, when a stroke for allowing the middle activator 67 to be slidable is made long, the ink attached to the concave 42 can be pushed out and completely sucked from even the deeply formed concave 42.

### B. Second Embodiment

In the first embodiment and the various modified examples of the first embodiment described above, the ink removing unit 60 is provided not in the cap unit 40 but in the head unit 30. However, the ink removing unit 60 may be provided in the cap unit 40. Hereinafter, a second embodiment will be described.

### B-1. Configuration of Apparatus

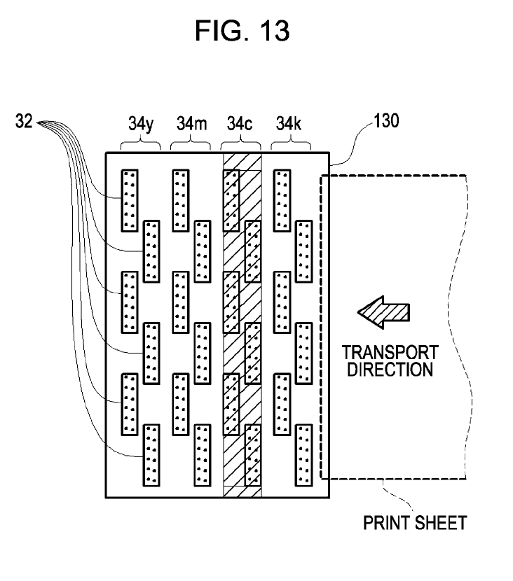

FIG. 13 is an explanatory diagram illustrating the shape of the bottom surface of the head unit 130 according to the second embodiment. As illustrated, the head unit 130 according to the second embodiment is different from the head unit 30 according to the first embodiment described above with reference to FIGS. 3A and 3B in that the ink removing unit 60 is not provided and the remaining configuration is the same.

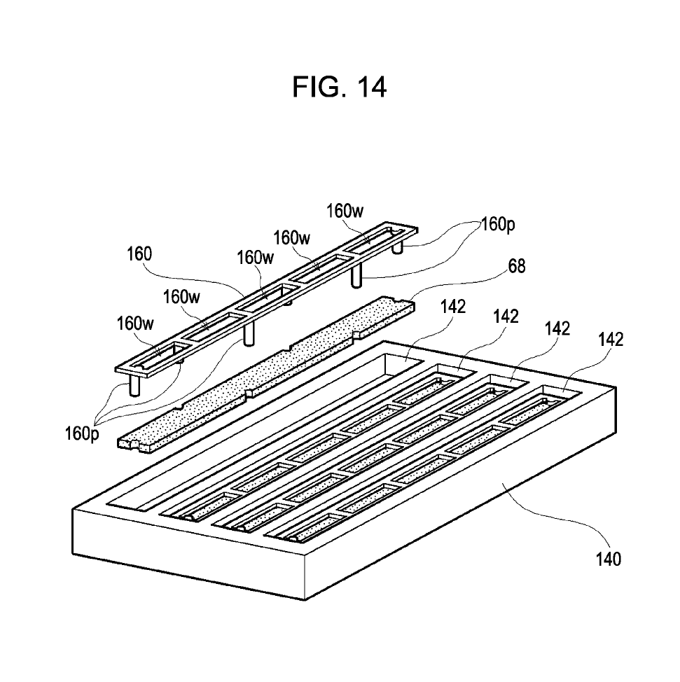

FIG. 14 is a perspective view illustrating a substantial shape of the cap unit 140 according to the second embodiment. As illustrated, the cap unit 140 according to the second embodiment has a substantially tetragonal shape. On the upper surface of the cap unit 140, thin long concaves 142 receiving ink are provided at positions corresponding to the ejection heads arranged on the bottom surface of the head unit 130. As shown in FIG. 13, four ejection heads are provided in the head unit 130 according to the second embodiment and four concaves 142 are provided in the cap unit 140 in correspondence with the four ejection heads.

An ink absorbing member 68 having a thin long substantial tetragon and an ink removing auxiliary member 160 pressing the ink absorbing member 68 are received in each of the concaves 142. The ink absorbing member 68 made of a porous material such as a non-woven fabric having sufficiently high elasticity absorbs the ink of the concave 142 by an operation of a surface tension and can store the ink therein. The ink removing auxiliary member 160 is a plate-shaped member made of hard resin or metal. A plurality of large windows 160w are formed in the plate-shaped ink removing auxiliary member 160 and a plurality of small pistons 160p having a substantial column protrude in the lower surface (a surface contacting with the ink absorbing member 68) of the ink removing auxiliary member 160.

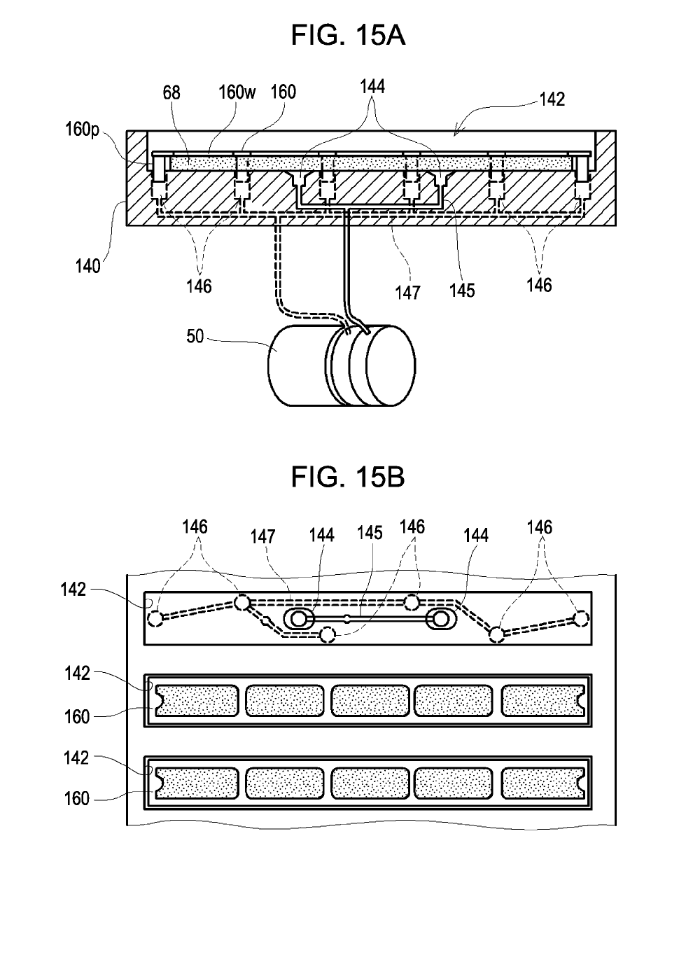

FIGS. 15A and 15B are explanatory diagrams illustrating the detailed configuration of the cap unit 140. In FIG. 15A, the configuration of the cap unit 140 is shown by taking the cross-section along the longitudinal direction nearly at the middle location of the concave 142. In FIG. 15B, the configuration of the cap unit 140 is shown in a state where the ink removing auxiliary member 160 and the ink absorbing member 68 are removed, when the concave 142 is viewed from the upper surface.

As shown in FIGS. 15A and 15B, a plurality of recessed portions 146 formed through the bottom surface in the substantially cylindrical shape are formed on the bottom surface of the concave 142. Each of the recessed portions 146 is connected to the suction pump 50 through a negative passage 147 formed inside the cap unit 140. As described above with reference to FIG. 14, the plurality of small pistons 160p protrude on the lower surface of the ink removing auxiliary member 160. By fitting the pistons 160p to the recessed portions 146 formed in the concave 142, the ink removing auxiliary member 160 is assembled to the concave 142 with the ink absorbing member 68 interposed therebetween.

Openings 144 for sucking the ink are formed on the lower portion of each of the concaves 142. The openings 144 are also connected to the suction pump 50 through a sucking passage 145 formed inside the cap unit 140. For easy understanding, in FIGS. 15A and 15B, the recessed portions 146 and the negative passage 147 connected to the recessed portions 146 are indicated by dashed lines. In addition, the openings 144 and the sucking passage 145 connected to the openings 144 are indicated by full lines.

As in the above-described first embodiment, the various maintenance processes such as the flushing process, the cleaning process, the capping process are also performed to prevent the ink of the ejection heads 34 from being thickened in the line printer 1 according to the above-described second embodiment. Since the ink absorbing member 68 is provided in each of the concaves 142 of the cap unit 140, the ink ejected in the flushing process does not travel from the concave 142. Moreover, in the capping process, the ink of the ejection head 34 can be prevented from being thickened since appropriate humidity in the concave 142 is maintained due to the ink absorbed by the ink absorbing member 68.

However, when the ink absorbed by the ink absorbing member 68 remains unremoved, the ink absorbing member 68 is clogged and thus cannot absorb the ink. Moreover, when the absorbed ink is dried and solidified, the ink of the ejection head 34 may be rather thickened more rapidly due to the capping process. Accordingly, in the line printer 1 according to the second embodiment, a function of absorbing the ink absorbed by the ink absorbing member 68 can be maintained, by providing the ink removing auxiliary member 160 having a substantially flat board shape together with the ink absorbing member 68 in the concave 142 and performing a hollow sucking process. Hereinafter, this process will be described in detail.

### B-2. Process of Maintaining Function of Ink Absorbing Member

For convenient description, sucking the ink in the cleaning process will be first described. In addition, based on this description, a process of maintaining the function of the ink absorbing member 68 by performing the hollow sucking process by the line printer 1 according to the second embodiment will be described.

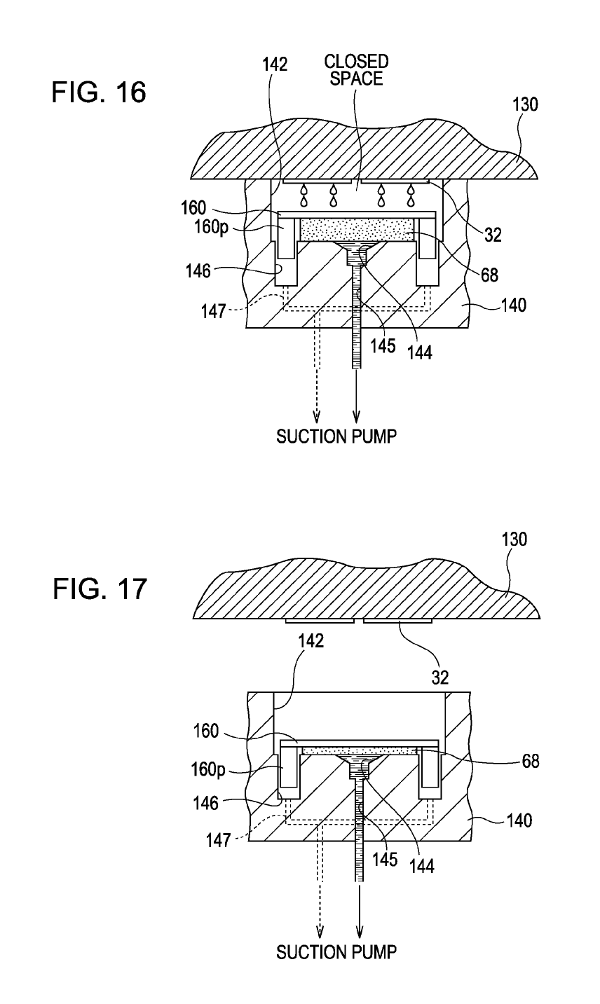

FIG. 16 is an explanatory diagram showing that a line printer 1 performs the cleaning process of sucking ink from ejection nozzles according to the second embodiment. In FIG. 16, the configuration of one concave 142 is simply shown. As described above, the ink absorbing member 68 is provided in the concave 142 and the ink removing auxiliary member 160 having the substantially flat board shape is provided above the ink absorbing member 68. The pistons 160p protruding on the lower surface of the ink removing auxiliary member 160 are fitted to the recessed portions 146 formed on the bottom surface of the concave 142. When the cap unit 140 according to the second embodiment is brought into contact with the bottom surface of the head unit 130, a closed space where the nozzle unit 32 is contained is formed between each of the concaves 142 of the cap unit 140 and the head unit 130. In this state, when the suction pump 50 operates, the negative pressure from the suction pump 50 transfers to the opening 144 through the sucking passage 145 and simultaneously transfers to the recessed portions 146 through the negative pressure passage 147.

In that the ink absorbing member 68 is made of a porous material such as a non-woven fabric, when the opening 144 becomes a negative pressure state, the closed space also becomes the negative pressure state, thereby forcibly sucking the ink from the ejection nozzles of the nozzle unit 32. Even when the recessed portions 146 become the negative pressure state, the pistons 160p of the ink removing auxiliary member 160 are sucked with the same force both from the side of the lower surface (the side of the recessed portions 146) and from the side of the upper surface (the side of the closed space), since the closed space also becomes the negative pressure. Accordingly, during the cleaning process, the ink removing auxiliary member 160 is not driven by the pistons 160p.

FIG. 17 is an explanatory diagram showing that the line printer 1 performs the hollow sucking process in a state where the cap unit 140 does not come in contact with the head unit 130 according to the second embodiment. Even when the cap unit 140 comes in contact with the head unit 130 and the hollow sucking process is performed in a state where air can be introduced into the concave 142 by opening an air opening value (not shown), the above description can be applied likewise.

In FIG. 17, when the suction pump 50 operates in a state where the cap unit 140 is distant from the head unit 130, the negative pressure generated by the suction pump 50 transfers to the opening 144 and the recessed portions 146 through the sucking passage 145 and the negative pressure passage 147, respectively. However, unlike the cleaning process shown in FIG. 16, since the closed space is not formed in the concave 142 at the time of performing the hollow sucking process, the negative pressure is not exerted on the side of upper surface of the pistons 160p and the negative pressure is exerted only in the side of the lower surface. In consequence, the pistons 160p moves downward due to the pressure difference between the side of the upper surface and the side of the lower surface while pressing the ink absorbing member 68. At this time, the ink absorbed by the ink absorbing member 68 is squeezed and discharged from the opening 144 through the sucking passage 145.

In this way, in the line printer 1 according to the second embodiment, the ink absorbed by the ink absorbing member 68 can be squeezed and discharged from the opening 144 by performing the hollow sucking process. Accordingly, it is possible to prevent the ink of the ejection head 34 from being thickened more rapidly since the ink absorbed by the ink absorbing member 68 is solidified and deprived of water from the ink of the ejection nozzles in the capping process.

Since the pressure difference generated in the pistons 160p is removed at the time of ending the hollow sucking process to stop the operation of the suction pump 50, the ink absorbing member 68 restores the state prior to the hollow sucking process due to the elasticity of the ink absorbing member 68, while pushing up the ink removing auxiliary member 160. Thereafter, when the ink is absorbed by the ink absorbing member 68 by performing the flushing process (or the cleaning process) again, the new ink (which is not dried) can be typically absorbed by the ink absorbing member 68. Accordingly, by maintaining the humidity in the closed space formed around the ejection nozzles in the capping process, it is possible to prevent the ink of the ejection nozzles from being thickened.

A main mechanism for compressing the ink absorbing member 68 has only the ink removing auxiliary member 160 having the pistons 160p and the negative passage 147 formed inside the cap unit 140, all of which can be received in the cap unit 140. Accordingly, it is possible to embody a very simple and miniature configuration, compared to a case of mounting a special mechanism for compressing the ink absorbing member 68.

Since the ink is forcibly sucked out from the ejection nozzles during the cleaning process, a large amount of ink is discharged from the opening 144. Accordingly, when the ink absorbing member 68 is compressed during the cleaning process, it is difficult to discharge the large amount of ink or the thickened ink due to the resistance of the ink absorbing member 68. Accordingly, in the line printer 1 according to the second embodiment, the ink absorbing member 68 is not compressed by the ink removing auxiliary member 160 during the cleaning process, as described above with reference to FIG. 16. With such a configuration, the large amount of ink or the thickened ink can be discharged from the opening 144.

### B-3. First Modified Example

In the above-described second embodiment, the ink absorbing member 68 is made of a material having sufficiently high elasticity. Moreover, when the compressing force is removed from the ink removing auxiliary member 160, the ink absorbing member 68 restores the original shape due to its elasticity. However, the ink removing auxiliary member 160 may not restore the original shape due to its elasticity. Instead, an elastic member for restoring the ink removing auxiliary member 160 may be separately provided.

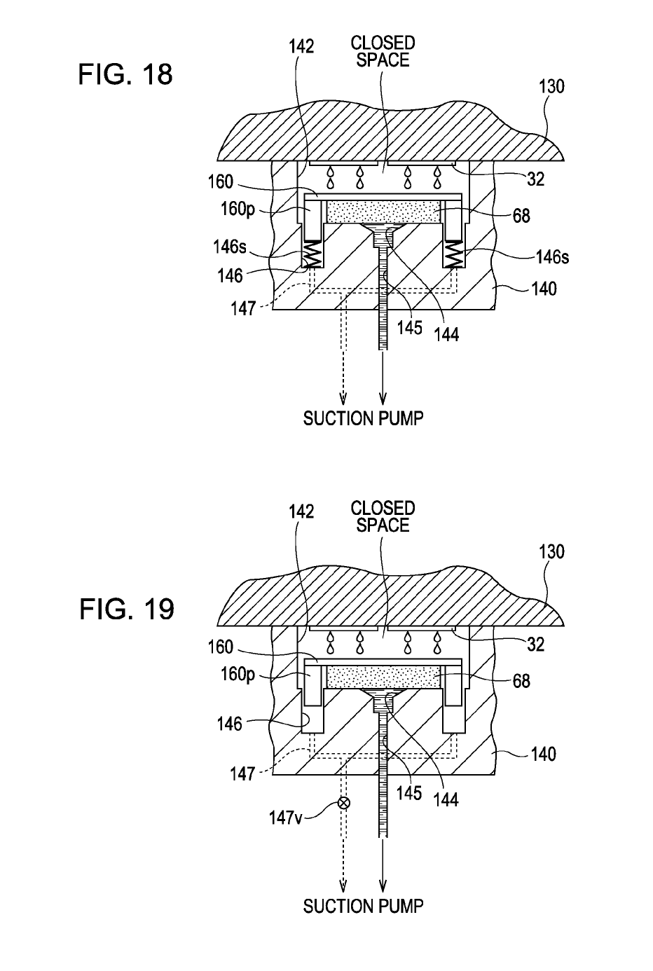

FIG. 18 is an explanatory diagram illustrating a spring member for restoring the ink removing auxiliary member 160 according to a first modified example of the second embodiment. In an illustrated example, a small coil spring 146s is received in each of the recessed portions 146. The ink removing auxiliary member 160 and the ink absorbing member 68 are adhered to each other. When the ink removing auxiliary member 160 compresses the ink absorbing member 68, the ink absorbing member 68 and the coil springs 146s are simultaneously compressed. However, a force for compressing the ink absorbing member 68 is removed, the coil springs 146s push up the pistons 160p. The ink absorbing member 68 can restore the original shape due to this force.

With such a configuration, a restoring force for returning the original shape may not be taken into consideration when the material or the shape of the ink absorbing member 68 is examined. In consequence, since the material or the like can be examined in focus of an easy ink absorption property, a capability to maintain the absorbed ink, or the like, a more appropriate ink absorbing member 68 can be embodied.

### B-4. Second Modified Example

In the above-described second embodiment, the suction pump 50 and the recessed portions 146 communicate with each other through the negative pressure passages 147. Moreover, when the suction pump 50 operates, the negative pressure is necessarily guided to the recessed portions 146. However, by providing a switching valve 147v in the negative passage 147 and not opening the switching valve 147v, the negative pressure from the suction pump 50 may not be guided to the recessed portions 146.

FIG. 19 is an explanatory illustrating the switching valve 147v provided in the negative pressure passage 147 according to a second modified example of the second embodiment. With such a configuration, when it is intended not to apply the negative pressure to the recessed portions 146, the negative pressure cannot be applied by closing the switching valve 147v. For example, when the flushing process is performed in a case of closing the switching valve 147v, the flushing process can be performed without compression of the ink absorbing member 68. In addition, when the switching valve 147v is closed during the cleaning process, the negative pressure is applied from the suction pump 50 and the pressure in the concave 142 is lowered. However, the pressure of the recessed portion 146 is not lowered. In consequence, a pushing force in a direction from the recessed portions 146 to the concave 142 is exerted in the pistons 160p. Accordingly, when the upper surface of the ink absorbing member 68 is adhered to the ink removing auxiliary member 160, for example, the ink absorbing member 68 can restore the original shape.

The line printer 1 according to the embodiments and the several modified examples of the embodiments has been described, but the invention is not limited to the embodiments and modified examples described above. The invention may be modified in various forms without departing the gist of the invention.

For example, in the several embodiments and modified examples described above, a so-called line printer capable of printing an image by not moving the head unit 30 or the head unit 130 but transporting the print sheet has been described. However, the invention is also applicable to a serial printer capable of printing an image while reciprocating the nozzle unit 32 on the print sheet.

In the first embodiment and the several modified examples of the first embodiment described above, the ink removing unit 60 has been mounted on the head unit 30. However, the ink removing unit 60 may not necessarily be mounted on the head unit 30, but may be provided separately from the head unit 30.

In the several embodiments and modified examples described above, the cap unit 40 or the cap unit 140 has been used in the cleaning process and the capping process as well as the flushing process. However, the invention is also applicable to a cap unit used only for the flushing process.

The entire disclosure of Japanese Patent Application Nos. 2008-157541, filed Jun. 17, 2008, 2009-098721, filed Apr. 15, 2009, 2008-182383, filed Jul. 14, 2008 are expressly incorporated by reference herein.

What is claimed is:

1. A liquid ejecting apparatus that ejects a liquid from ejection nozzles formed in an ejection head, the liquid ejecting apparatus comprising:
a liquid receiver that is provided with a concave receiving the liquid from the ejection head;
a suction pump that is connected to an opening formed in the concave and sucks the liquid in the concave; and
a sucking auxiliary member that is applied with a negative pressure from the suction pump and drawn into the concave in a direction of the opening to assist the process of sucking the liquid in the concave by the suction pump.

2. The liquid ejecting apparatus according to claim 1,
wherein the sucking auxiliary member is provided at a position different from that of the ejection head and comes in contact with the liquid receiver to form a closed space together with the concave, and
wherein the sucking auxiliary member is drawn in the direction of the opening to decrease the volume of the closed space when the suction pump operates in the state where the closed space is formed to assist the process of sucking the liquid by the suction pump.

3. The liquid ejecting apparatus according to claim 2, further comprising:
a liquid absorbing member that is provided in the concave and absorbs the liquid,
wherein the sucking auxiliary member is drawn into the concave in the direction of the opening to compress the liquid absorbing member.

4. The liquid ejecting apparatus according to claim 2, further comprising:
a first driving unit that brings the liquid receiver into contact with the ejection head by driving at least one of the liquid receiver and the ejection head; and
a second driving unit that changes a relative position between the liquid receiver and the ejection head by driving at least one of the liquid receiver and the ejection head,
wherein the sucking-operation auxiliary member is provided close to the ejection head and comes in contact with the liquid receiver by changing a relative position to the liquid receiver by the first and second driving units.

5. The liquid ejecting apparatus according to claim 2, wherein the sucking auxiliary member is formed of an elastic air-tight film and applied with the negative pressure from the suction pump to be drawn toward the concave when the suction pump operates in the state where the closed space is formed together with the concave.

6. The liquid ejecting apparatus according to claim 5, wherein in the liquid receiver, a portion where the side surface and the bottom surface of the concave intersect one another is formed in a curved shape.

7. The liquid ejecting apparatus according to claim 2,
wherein the sucking auxiliary member includes a middle portion that forms the closed space when the liquid receiver is contacted and a peripheral portion that is provided in periphery of the middle portion and comes in contact with the liquid receiver, and
wherein the middle portion is slidable with respect to the peripheral portion and the middle portion is drawn into the concave when the suction pump operates in the state where the closed space is formed.

8. The liquid ejecting apparatus according to claim 1,
wherein a liquid absorbing member absorbing the liquid, the sucking auxiliary member provided in a space with an inner wall surface of the concave with the liquid absorbing member interposed therebetween, and a recessed portion to which the sucking auxiliary member is drawn are formed in the concave,
wherein the suction pump is connected to the recessed portion in addition to the opening, and
wherein the sucking auxiliary member compresses the liquid absorbing member when the sucking auxiliary member is applied with the negative pressure from the suction pump and drawn to the recessed portion.

9. The liquid ejecting apparatus according to claim 8, further comprising:
a driving unit that brings the liquid receiver into contact with the ejection head by driving at least one of the liquid receiver and the ejection head,
wherein the liquid receiver forms a closed space in the concave when the liquid receiver is brought into contact with the ejection head, and
wherein the sucking auxiliary member is drawn to the recessed portion due to a pressure difference generated between the recessed portion and the concave when the suction pump operates.

10. The liquid ejecting apparatus according to claim 8, wherein the liquid absorbing member restores its volume due to its restoring force when a compression force is removed from the sucking auxiliary member.

11. The liquid ejecting apparatus according to claim 8, wherein the sucking auxiliary member includes a restoring member that is elastically deformed by a force compressing the liquid absorbing member and restores the volume of the liquid absorbing member when a compression force from the sucking auxiliary member against the liquid absorbing member is removed.
